(19) United States
(12) Patent Application Publication
(10) Pub. No.: US 2004/0013414 A1
(43) Pub. Date: Jan. 22, 2004

(54) Determining the position of an axis of rotation (patient positioning table, radiation therapy) on the basis of an angle of rotation and a chord through a movable mark

(76) Inventors: Christian Karger, Dossenheim (DE); Oliver Jackel, Dossenheim (DE); Gunther Hartmann, Heidelberg (DE)

Correspondence Address: WILLIAM COLLARD, COLLARD & ROE, P.C., 1077 NORTHERN BOULEVARD, ROSLYN, NY, 11576, US

(21) Appl. No.: 10/343,774

(22) PCT Filed: Aug. 6, 2001
(86) PCT No.: PCT/DE01/02924

(30) Foreign Application Priority Data
Aug. 4, 2000 (DE) 100 38 836.1

(51) Int. Cl. H04N 5/225

(52) U.S. Cl. 386/117

(57) ABSTRACT

For precision radiation therapy it is essential that the patient be positioned as accurately as possible with reference to the irradiation center (IC). To this end, an axis of rotation (TA) of a patient positioning table (7) is first determined in terms of its position and is then aligned correspondingly. For determining the position, a mark (5) is introduced into the isocenter (IC) of the irradiation device and rotates with the patient positioning table (7). The distance between the axis of rotation (TA) and the isocenter (IC) is determined on the basis of the distance (P, IC) traveled and the angle of rotation (φ), and the axis of rotation is then aligned correspondingly.

The invention relates to a method and a measuring arrangement for determining the position of an axis of rotation of a body with reference to a spatial point and a method for aligning a patient's table which can be rotated about an axis of rotation.

The invention on this occasion especially relates to the field of radiation therapy. As a rule, suitable irradiation devices have linear accelerators which are directed towards an irradiation centre, wherein the present invention can also be applied to other radiation sources.

With such devices an isocentre can be defined as the point of intersection of several axes, for example, an axis of rotation of a radiation source holder or a retaining clip, an axis of a collimator head, a beam axis or an axis of rotation of a patient's table. In practice, this isocentre is found to be the irradiation centre, i.e. the position at which the radiation is focussed during the treatment.

In this context, it is important especially for precision radiation therapy, which is no longer exclusively a research topic but has already been used in general health care, that these axes intersect as precisely as possible at the isocentre wherein deviations of several millimetres can occur in practice. However, an exact adjustment is required for precision radiation therapy and this particularly applies to the axis of rotation of a patient's table with respect to the other irradiation device. In this case, this axis of rotation is generally adjusted so that it runs vertically through the isocentre. This exact adjustment is generally extremely difficult since the axis of the table or the axis of rotation itself are not visible and especially can only be checked or determined mechanically with extreme difficulty.

For the adjustment of the table axis, the publication by G. H. Hartmann entitled “Quality assurance program on stereotactic radiosurgery” (Springer-Verlag, Heidelberg, 1995) provides that a test tip should be adjusted along the invisible axis of the table as part of a comprehensive examination of the adjustment of an irradiation unit. This is accomplished by moving the tip iteratively on the table until this no longer migrates with reference to space during a rotation of the table. The tip is then moved into the isocentre and the distance is measured. However, this method has the disadvantage that the test tip must be positioned iteratively which is relatively time-consuming. Furthermore, during the examination to determine whether the tip actually lies on the axis of the table, a very small movement of the tip must be determined during rotation of the table with reference to the surrounding space, which imposes relatively high requirements on the measurement accuracy. As a result of the large mass of the table, it may also be the case that the axis of the table does not lie completely rigidly in the space during the rotation so that the tip must be positioned at the centre of this so-called wobble movement in order to identify the central position of the table axis.

A further procedure for correcting for the migration of a target point positioned at the isocentre after a rotation of the table is described in the publication by Brezovich I. A., Pareek P. N, Plott W. E. and Jenelle R. L. S., “Quality assurance to correct for errors arising from couch rotation in linac-based stereotactic radiosurgery” (International Journal of Radiation Oncology Biology Physics 38, 883 to 890, 1997). In this case, the adjustment of the patient is first simulated beforehand. This is accomplished by positioning a test tip below the 0° position of the table at the isocentre and after the respective rotation, measuring the displacement back into the isocentre. The correction determined in this fashion is then implemented on the patient in the same fashion. In this respect, this involves a simulation of the patient's position with a subsequent correction which must be carried on every occasion for every patient. For this purpose each table angle must explicitly be regularly measured separately, which is relatively time-consuming. In the same way, every movement of the patient must be corrected.

On the other hand, DE 29 40 633 A1 discloses a method for determining the position of an axis of rotation of a body wherein the body is rotated starting from an initial position in two different angular positions, a tracer is provided on the body and the respective position of the tracer is measured. From the three points determined in this fashion, it is possible to determine a plane in which these three points lie. The direction of the axis of rotation follows from this. The point of intersection of the axis of rotation with this plane is obtained wherein a circle lying in this plane is determined by the three points, the central point defining the point of intersection. In view of the need to determine three points, this method appears relatively time-consuming, especially if merely the distance of the axis of rotation from the isocentre is required.

It is an object of the present invention to simplify or speed up the sequences which occur during the use of an irradiation device.

As a solution, the invention proposes on the one hand a method for determining the position of an axis of rotation of a body with reference to a spatial point, especially methods for determining the position of an axis of rotation of a patient's table with reference to the isocentre in which the spatial point is initially marked with a marker located on the body or on the patient's table, a rotation of the body or the patient's table about a selected angle is then made and the distance covered by the marker is then measured, wherein the distance vector between the spatial point and the axis of rotation is calculated using the distance covered and the selected angle of rotation.

In an irradiation device the important spatial point, say the isocentre, is generally already marked by laser light beams which intersect at the isocentre, or similar, where the beams are frequently fanned out at planes forming the XY, XZ and YZ planes. In this respect the marker merely needs to be adapted to these beams in a suitable fashion.

The magnitude of the distance as well as the direction can be determined from the distance vector so that the position of the axis of rotation can easily be determined. It is to be understood here than the concept of distance vector is to be understood here in its most general meaning, that is information on direction and magnitude. On the other hand, it is also feasible that if merely the distance or merely the direction are of interest, not the vector as such but the required quantities can be calculated directly.

In contrast to the methods known already, in the method of determining position according to the invention, the position of the axis of rotation is determined in a single measuring step and is thus available for further processing. The methods known to date require several measuring points or on the one hand proceed iteratively or store merely correction values which must then be retrieved for each treatment.

Accordingly, the invention further proposes a method for aligning a patient's table which can be rotated about an axis of rotation, especially for radiation therapy, in which the position of the axis of rotation is first determined and the table is then aligned such that the axis of rotation is located in its desired position.

With such a procedure which is carried out especially using the method of determining position described previously, it is possible to dispense with a subsequent corrective movement of the patient's table at each treatment step since the axis of rotation of the table can be precisely positioned, i.e., can be placed at the isocentre within the limits of the measurement accuracy. During a rotation of the table the patient thus remains positioned with reference to the irradiation centre within the limits of the measurement accuracy so that the treatment time can be shortened and thus the treatment can be made more pleasant for the patient.

Since the relevant spatial point, especially the isocentre, is already marked by the marker and suitable measuring equipment is thus available to be able to use the marker in its marking function, the marker can be moved back to the relevant spatial point in order to measure the distance covered and the distance covered here in the return movement can be measured.

In this respect, in this procedure for measuring distance according to the invention, no additional measuring devices need to be provided to detect the marker. There is merely a need to provide devices which can measure the distance covered in the return movement. These can be, for example, distance meters, stepping motors or the adjusting and measuring devices of an x-y measuring table.

This procedure especially has the advantage that precisely those measures can be used which are used in any case for local measurement of the marker at the selected spatial point. In this respect, there is no need for a new spatial point to be approached and adjusted by the corresponding measuring device or by the measures for local measurement of the spatial point. In this respect, the procedure is hereby made considerably easier.

To determine the position, the distance vector is preferably determined in each case for different angles of rotations, i.e., the marker is moved from the spatial point by a rotation of the body through different angles, the distance covered here by the marker is measured and the distance vector is calculated using the distance covered and the resnective angle. In this way it can be determined whether or how far the axis of rotation varies or wobbles during the rotation. Such a variation of the axis of rotation is especially difficult to eliminate with heavy patient's tables.

Depending on the scale of the variation, it may be sufficient to determine a mean position of the axis of rotation from the values determined and to suitably align this or the patient's table. On the other hand, these results can provide grounds for modifying the mechanics of the patient's table or the body in a suitable fashion to stabilise the axis of rotation. It is also feasible to compensate for these deviations caused by the rotation by means of suitable translational movements.

However, since the axis of rotation is already aligned as accurately as possible in the fashion according to the invention, such compensating movements are substantially smaller than the compensating movements which occur with a non-aligned axis of rotation so that the treatment time is only insignificantly lengthened by any after-compensation such as can be carried out in the method according to the invention.

To determine the position, at least a second distance vector between the axis of rotation and at least a second spatial point displaced about the principal direction of extension of the axis of rotation with reference to the first spatial point, can be determined and the direction of extension of the axis of rotation can be calculated from the distance vectors determined and the spatial points. In this case, it is merely necessary to construct a straight line through the feet of the two distance vectors which point to the respective spatial points.

If more than two snatial points, especially three spatial points, and a corresponding number of distance vectors are determined, the direction of extension of the axis of rotation is preferably calculated using suitable statistical methods. It is to be understood that this information can be used especially to align the body or the patient's table in a suitable fashion.

It is to be understood in this case that the principal direction of extension need not be predetermined since is accomplished precisely by the determination of position described. Rather a coarse displacement of the second spatial point in this direction is sufficient since the precise measurement is then made by determining the distance vector. It is to be understood in this case however, that the position of such a displaced spatial point must be determined sufficiently accurately.

The position of the axis of rotation is preferably determined at selected time intervals and the patient's table aligned subsequently if necessary. As a result of such a procedure, it is possible for variations to be corrected subsequently without the need for calibrating the irradiation device before every treatment as is provided in the prior art.

As a further solution, the invention proposes a measuring arrangement to determine the position of an axis of rotation of a body with reference to a spatial point, especially of a patient's table with respect to an isocentre, using a measuring table which is positioned with reference to the body by means of positioning means and which comprises a measuring tip, a device for adjusting the measuring tip with reference to the positioning means in at least two dimensions and a device for determining the adjusted distance.

Using such an arrangement, the method of determining position which has been described previously can easily be implemented. This method can especially be carried out relatively simply and quickly using such an arrangement.

The term “dimensions” extends in the present connection to all spatial dimensions, whether it be Cartesian coordinates, cylindrical coordinates or spherical coordinates where these need not necessarily be provided as fixed. What is important however is that the measuring tip should be adjustable with reference to the positioning means in two linearly independent dimensions.

It is also to be understood that other coordinate systems can also be used as long as these can be converted into the coordinate systems of this description of the invention by suitable transformations.

The device for determining the adjusted distance can comprise any conventional measuring arrangement for determining distance, such as suitable distance meters, adjusting or stepping motors or the like as long as the distance covered during the adjustment is accessible with sufficient measurement accuracy.

If the measuring table has an adjusting device for adjusting the measuring tip with reference to the positioning means in at least two dimensions, the direction of extension of the axis of rotation can easily be determined using this measuring arrangement, as has already been described previously.

If the measuring arrangement according to the invention is used in conjunction with a substantially horizontally arranged table, especially a patient's table, which is rotatable about an axis of rotation which has a vertical component, the positioning means can comprise a support by which means the measuring table lies on the patient's table or is supported thereon. As a result of the horizontal alignment of the table, the measuring table remains in its position on the patient's table if this rotates. It is to be understood that such an arrangement is build extraordinarily simply and therefore cheaply.

By means of a suitable choice of measuring table or adjusting device and of the device for determining the adjusted distance for which a known x-y measuring table can also be used, for example, the measuring arrangement can be implemented extremely cheaply.

The measuring arrangement is also built relatively simply and cheaply if intersecting beams are used as means for marking the spatial point. Such intersecting beams can preferably be laser light beams which can easily be aligned with high accuracy.

Moreover, irradiation devices frequently have laser light beams for marking the isocentre so that these laser light beams can be used in a suitable fashion. In order to ensure simple alignment of the measuring tip, this can have a measuring head which interacts with these beams in a suitable fashion. In this case, the measuring head can be selected, for example, such that it makes the beams visible whereby the measuring head or the measuring tip are aligned relatively simply at the point of intersection.

Further advantages, goals and properties of the present invention are explained with reference to the description of the drawings, wherein:

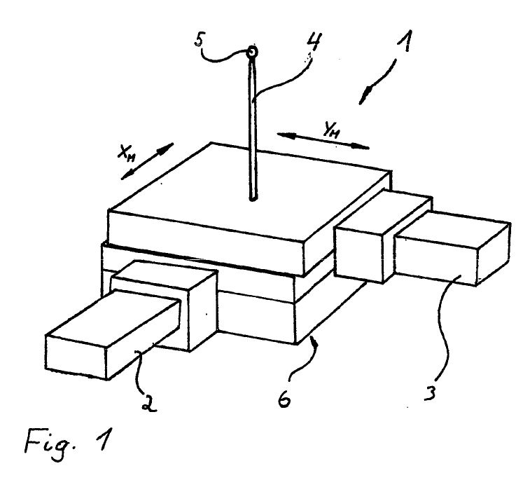

FIG. 1 is a perspective schematic view of a measuring table for a measuring arrangement according to the invention and

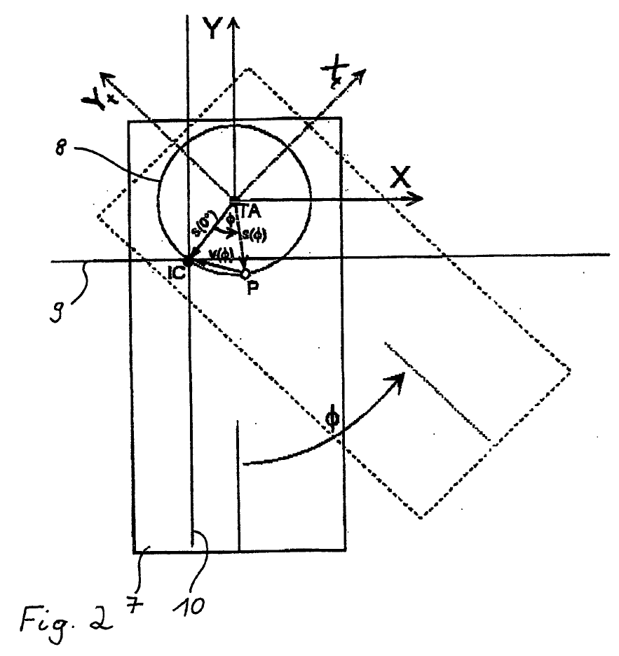

FIG. 2 is a diagram of the geometric relationships during the determination of position.

The measuring table 1 shown in FIG. 1 is an x-y measuring table on which a measuring tip 4 can be adjusted in two dimensions, namely X_{M} and Y_{M} via two adjusting devices 2,3. The adjusting devices 2,3 are micrometer drives which can position the measuring tip with an accuracy of 0.01 mm and are capable of outputting their adjustment position or the distance covered by them.

On the measuring tip a sphere 5 having a diameter of 5 mm is attached as a measuring head which is covered with an orange dye which especially interacts with the lines of laser light from the irradiation device such that these lines of laser light are optimally visible. It is to be understood that in other embodiments, depending on the beams or laser beams used, other measures or other dyes can be used to represent a marker.

The measuring table 1 has a flat underside 6 which serves as a support to position the measuring table 1 on a patient's table 7 (see FIG. 2). When placed on the patient's table 7, the measuring table 1 is preferably aligned so that the X_{M} and Y_{M} axes are aligned along the table axes Xₜ and Yₜ. In this way, any further correction during a transformation of coordinates to be performed subsequently can be dispensed with.

In a preferred embodiment, the positioning means according to the invention comprise aligning means such as suitable groove-spring arrangements, recesses and/or pin-hole-plug connections which facilitate or obviate the need for such alignment.

After the measuring table 1 has been positioned on the patient's table 7, the measuring head 5 is brought into the isocentre of the irradiation device. This can be accomplished on the one hand by displacing the entire measuring table 1. On the other hand, the adjusting devices 2 and 3 of the measuring table 1 can also be used for this.

If the measuring head 5 is arranged at the isocentre of the irradiation device, it is separated from the axis TA (table axis) by the distance vector s(0). Precisely this distance or distance vector needs to be determined. In this case, this distance vector s is defined in a spatially fixed coordinate system X, Y, Z and rotates in a coordinate system Xₜ, Yₜ, Zₜ which is fixed with respect to the patient's table 7. If the patient's table 7 is now rotated through an angle φ about the axis of rotation TA, the measuring head 5 follows this rotation along a circular path 8. After passing through the angle of rotation φ, the measuring head 5 thus reaches the point P which is denoted by the distance vector s(φ) in the spatially fixed coordinate system X, Y, Z. In this case s(φ) is given by

s(φ)=R(φ)s(0°)

under the matrix of rotation

$$R ( φ ) = ( \begin{matrix}cos φ & - sin φ \\ sin φ & cos φ\end{matrix} )$$

as a function of the angle of rotation φ. As can be seen directly from FIG. 2, the vector ν(φ) for which the following condition is satisfied

s(0°)=s(φ)+ν(φ)

and which extends from the point P to the isocentre IC, denotes the distance which is required to displace the measuring head 5 back into the isocentre IC. In the present measuring arrangement this return movement distance ν(φ) will be covered by adjusting the adjusting devices 2 and 3 where the distance covered is to be given in the coordinates of the patient's table Xₜ, Yₜ, Zₜ and is thus denoted by νₜ(φ). As a result of transforming the coordinates it hereby follows that

ν(φ)=R(φ)νₜ(φ)

A corresponding inverse transformation gives

s(0°)=(R(−φ)−1)⁻¹νₜ(φ)

or

$$\begin{matrix}{s}_{x} ( {0}^{∘} ) = - \frac{1}{2} ( {v}_{t , x} ( φ ) + {v}_{t , y} ( φ ) cot \frac{φ}{2} ) \\ {s}_{y} ( {0}^{∘} ) = \frac{1}{2} ( {v}_{t , x} ( φ ) cot \frac{φ}{2} - {v}_{t , y} ( φ ) )\end{matrix}$$

in individual coordinates for the distance vector s(0°) from the axis of rotation TA of the patient's table to the isocentre.

It is to be understood that by selecting various angles of rotation φ, a mean value can be calculated or a displacement of the axis of translation as a function of an angle of rotation φ can be determined. By means of this information, in cases of larger deviations, suitable measures such as an improved support or the like, can be provided to avoid such deviations. If the deviations are within the desired accuracy, these can be tolerated and the mean value used for alignment.

The direction of extension of the axis of rotation TA can be determined by varying the height of the measuring tip 4. In this case, the measuring head 5 is arranged not at the isocentre IC but at the point of intersection of the X isoline 9 and the Y isoline 10 which are denoted by laser light beams, i.e., displaced in the Z direction or the direction of extension of the axis of rotation TA towards the isocentre IC. In this case also, by means of a suitable choice of number of measuring points, a mean for the direction of extension and a corresponding statistical deviation can be determined which makes predictions on the accuracy.

1. A method for determining the position of an axis of rotation (TA) of a body (7) with reference to a spatial point (IC) in which the spatial point is initially marked with a marker (5) located on the body (7) and a rotation of the body (7) about a selected angle (φ) is then made and the distance (νₜ) covered by the marker (5) in this case is measured, characterised in that the distance vector (s(0)) between the spatial point (IC) and the axis of rotation (TA) is calculated using the distance covered (νₜ) and the selected angle of rotation (φ).

2. The method for determining position according to claim 1 characterised in that for a measurement of the distance covered (νₜ) the marker (5) is moved back to the spatial point (IC) and the distance covered by the backward movement is measured.

3. The method for determining position according to claim 1 or 2 characterised in that the distance vector for various angles of rotation is determined to determine the position.

4. The method for determining position according to one of claims 1 to 3 characterised in that to determine the position, at least a second distance vector between the axis of rotation (TA) and at least a second spatial point displaced about the principal direction of extension of the axis of rotation (TA) with reference to the first spatial point (IC) is determined and the direction of extension of the axis of rotation is calculated from the distance vector and the spatial points.

5. The method for aligning a patient's table rotatable about an axis of rotation (TA), especially for radiation therapy, in which the position of the axis of rotation (TA) is initially determined, preferably by means of a position determining method according to one of claims 1 to 4 and the table (7) is then aligned such that the axis of rotation (TA) is located in its desired position.

6. The method according to claim 5 characterised in that the position of the axis of rotation (TA) is determined at selected time intervals and the table (7) is subsequently aligned if necessary.

7. A measuring arrangement for determining the position of an axis of rotation (TA) of a body (7) with reference to a spatial point (IC), characterised by a measuring table (1) which is positioned with reference to the body (7) via positioning means (6) and which comprises a measuring tip (4), a device (2, 3) for adjusting the measuring tip with reference to the positioning means (6) in at least two dimensions (X_{M}, Y_{M}) as well as a device for determining the adjusted distance (νₜ).

8. The measuring arrangement according to claim 7 characterised by an adjusting device for adjusting the measuring tip (4) with reference to the positioning means (6) in at least three dimensions (X_{M}, Y_{M}, Z).

9. The measuring arrangement according to claim 7 or 8 characterised in that the body (7) comprises a substantially horizontally arranged table (7) which is rotatable about an axis of rotation (TA) which has a vertical component, and the positioning means (6) comprises a support (6) by which means the measuring table (1) lies on the table (7).

10. The measuring arrangement according to one of claims 7 or 9 characterised by means for marking the spatial points by means of intersecting beams, preferably laser light beams, and by a measuring head (5) arranged on the measuring tip, which interacts with these beams and preferably makes these visible.
